(19) United States
(12) Patent Application Publication
(10) Pub. No.: US 2025/0139237 A1
(43) Pub. Date: May 1, 2025

(54) COLD START USER ACTIVITY ANOMALY DETECTION IN CLOUD COMPUTING ENVIRONMENT

(71) Applicant: Sophos Limited, Abingdon (GB)

(72) Inventors: Mohit Munjal, Karnal (IN); Arun Singh, Somerville, MA (US)

(21) Appl. No.: 18/928,494

(22) Filed: Oct. 28, 2024

(30) Foreign Application Priority Data
Oct. 31, 2023 (IN) 202311074325

(51) Int. Cl. G06F 21/55; G06N 7/01

(52) U.S. Cl. CPC G06F 21/552; G06N 7/01; G06F 2221/034

(57) ABSTRACT

A system and method for detecting cold start user activity anomalies in a cloud computing environment comprise an anomaly detection system collecting historical activity data of users of a plurality of endpoint computers arranged in an account. An average user baseline behavior model is trained for the account from the historical activity data of the users arranged in the account. The anomaly detection system applies the average user baseline behavior model to a cold start user activity and detects an anomaly in response to a comparison between the cold start user activity and the average user baseline behavior model. The anomaly detection system displays an alert based on a determination from the comparison that at least one anomaly of the plurality of anomalies is detected by the cold start user activity deviating from the average user baseline behavior model by a predetermined threshold.

### RELATED APPLICATIONS

This application claims priority to India Provisional Patent Application No. 20/2311074325 filed Oct. 31, 2023, entitled “COLD START USER ACTIVITY ANOMALY DETECTION IN CLOUD COMPUTING ENVIRONMENT,” the entirety of which is incorporated by reference herein.

### TECHNICAL FIELD

The present disclosure relates generally to cloud computer security. More specifically, the present disclosure describes the use of computer user activity log data of a user of a computer to determine anomalous behavior by cold start users in a cloud computing environment.

### BACKGROUND

Modern computer users can rely on cloud computing environments where security monitoring services can be performed on network-connected client devices. Large modern enterprises rely on cloud computing environments for the operation of thousands, tens of thousands, or even hundreds of thousands of electronic devices such as endpoint computers, each operated by one or more different users. Here, computer user activity may amount to the performance of millions or actions, or events, every day in their cloud computing environments, resulting in a massive amount of user activity data that renders security monitoring infeasible or prone to error.

Cybersecurity tools and monitoring services may perform anomaly detection operations to analyze user activity on computers to identity deviations and investigate inconsistent data indicative of malicious activity. These anomaly detection techniques analyze historical logging events from cloud environments to learn users' past activity patterns and flag any potentially suspicious patterns when a user's current activity deviates from their past behavior (normal). In large cloud computing environments, new users and roles are continuously created. For such new users, commonly referred to as “cold-start users,” as well as for users who exhibit minimal activity within the cloud environment, there exists a lack of historical data from which to derive past activity patterns. Consequently, conventional methodologies for training anomaly detection models that learn the baseline normal user behavior from a user's historical activity data may be infeasible for these user categories.

Rule-based approaches may be used to flag alerts based on hardcoded predefined rules instead of anomalous user behavior, which is unavailable for new users. However, rule-based anomaly detection techniques alone can result in high false positive rates. For example, a rule may establish that an alert is to be generated when a user performs an “access denied” error event. However, there may be some users in a particular environment, for example, a company or other organization, who trigger this rule frequently due to the nature of their role in their organization. In doing so, a high frequency of false positive alerts may be generated.

### SUMMARY

According to embodiments, disclosed herein are a method and associated computer system and computer program product for detecting cold start user activity anomalies in a cloud computing environment. One or more processors of an anomaly detection system receives historical activity data of users of a plurality of endpoint computers, the users arranged in an account. The anomaly detection system analyzes logging events of the historical activity data to learn historical activity patterns for the users in the account, trains an average user baseline behavior model for the account from the historical activity patterns, learns a plurality of anomaly detection model parameters from the average user baseline behavior model, applies the anomaly detection model parameters to a cold start user activity, detects a plurality of anomalies in response to a comparison between the cold start user activity and the average user baseline behavior model; and displays an alert based on a determination from the comparison that at least one anomaly of the plurality of anomalies is detected by the cold start user activity deviating from the average user baseline behavior model by a predetermined threshold.

In other embodiments, a method for detecting anomalies in a cloud computing environment, comprises training, by the anomaly detection system, an account level user baseline behavior model for an account from activity patterns of a plurality of computer users of an account; generating, in response to training the average user baseline behavior model, an average user behavior model of the account; combining, by the anomaly detection system, the average user baseline behavior model and at least one predefined rule to an activity performed by a cold start user of the plurality of computer users; and detecting, by the anomaly detection system, an anomaly in response to a comparison between the activity of the cold start user and the average user baseline behavior model. The anomaly detection system displays an alert based on a determination from the comparison that the anomaly is detected by the cold start user activity deviating from the average user baseline behavior model by a predetermined threshold.

In other embodiments, a computer program product for prioritizing security events comprises computer-readable program code executable by one or more processors of a computer system to cause the computer system to detect anomalies in a cloud computing environment comprising: training an account level user baseline behavior model for from activity patterns of a plurality of computer users of an account; creating, in response to training the average user baseline behavior model, an average user behavior model of the account; combining the average user baseline behavior model and at least one predefined rule to an activity performed by a cold start user of the plurality of computer users; detecting, by the anomaly detection system, an anomaly in response to a comparison between the activity of the cold start user and the average user baseline behavior model; and displaying an alert based on a determination from the comparison that the anomaly is detected by the cold start user activity deviating from the average user baseline behavior model by a predetermined threshold.

### BRIEF DESCRIPTION OF THE DRAWINGS

The above and further advantages of the disclosed concepts and features may be better understood by referring to the following description in conjunction with the accompanying drawings, in which like reference numerals indicate like elements and features in the various figures. For clarity, not every element may be labeled in every figure. The drawings are not necessarily to scale, emphasis instead being placed upon illustrating the principles of the disclosed concepts and features.

FIG. 1 depicts a block diagram of a computing environment that includes an anomaly detection system, in accordance with an example embodiment.

FIG. 2 depicts a method for activity anomaly detection, in accordance with an example embodiment.

FIG. 3 depicts a method for cold start user activity anomaly detection that includes behavior-based detections, in accordance with an example embodiment.

FIG. 4A depicts a diagram illustrating examples of model inputs for a user session, in accordance with an example embodiment.

FIG. 4B depicts a diagram illustrating examples of account/cold start model inputs for an account session, in accordance with an example embodiment.

FIG. 5 depicts a block diagram of a model learning normal behavior, in accordance with an example embodiment.

FIG. 6 depicts a block diagram of a model flagging abnormal behavior, in accordance with an example embodiment.

FIG. 7 depicts a diagram of a model establishing conditions for flagging abnormal behavior, in accordance with an example embodiment.

FIG. 8 depicts a diagram of a line along which a probability deviation range is illustrated for a set of anomaly confidence buckets, in accordance with an example embodiment.

FIG. 9 depicts a block diagram of an arrangement of anomaly confidence bucket categories, in accordance with an example embodiment.

FIG. 10 depicts a block diagram of an anomaly detection architecture, in accordance with an example embodiment.

FIG. 11 depicts a screenshot of an anomaly alert displayed at a computer display, in accordance with an example embodiment.

FIG. 12 depicts a screenshot of an anomaly alert displayed at a computer display, in accordance with another example embodiment.

FIG. 13 depicts a block diagram of a threat management facility, in accordance with an example embodiment.

FIG. 14 depicts a diagram of a computing device, in accordance with an example embodiment.

### DETAILED DESCRIPTION

Reference in the specification to “one embodiment” or “an embodiment” means that a particular, feature, structure or characteristic described in connection with the embodiment is included in at least one embodiment of the teaching. References to a particular embodiment within the specification do not necessarily all refer to the same embodiment.

The present teaching will now be described in more detail with reference to exemplary embodiments thereof as shown in the accompanying drawings. While the present teaching is described in conjunction with various embodiments and examples, it is not intended that the present teaching be limited to such embodiments. On the contrary, the present teaching encompasses various alternatives, modifications and equivalents, as will be appreciated by those of skill in the art. Those of ordinary skill having access to the teaching herein will recognize additional implementations, modifications and embodiments, as well as other fields of use, which are within the scope of the present disclosure as described herein.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “approximately” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms.

It should also be understood that endpoints, devices, compute instances, or the like that are referred to as “within” an enterprise network may also be “associated with” the enterprise network, e.g., where such assets are outside an enterprise gateway but nonetheless managed by or in communication with a threat management facility or other centralized security platform for the enterprise network. Thus, any description referring to an asset within the enterprise network should be understood to contemplate a similar asset associated with the enterprise network regardless of location unless a different meaning is explicitly provided or otherwise clear from the context.

In brief overview, embodiments herein are directed to systems and methods for anomaly detection of computer activity performed by new users, generally referred to as cold start users. Since a cold start user has no history of preferences, known computer activity, or the like, the systems and methods rely on the activity data of users who are in a same or similar environment as the cold start user. The cold start user computer activity is evaluated under an anomaly detection model, which is trained by learning a baseline normal user behavior from historical data of the other users of the same or similar environment. The activity data from a cold start user can be benchmarked against the baseline normal user behavior learned by the model so that deviations, or anomalies, can be flagged if a particular new user computer activity deviates from that of an average user. In particular, the system learns average user behavior activity patterns using historical data across one or more users (e.g., all users) in the account. This approach allows the system to flag anomalies based on a deviation from an average user normal behavior instead of relying on hardcoded, inflexible rules and thresholds. In doing so, false positive rates can be reduced over conventional rules-based approaches. Referring again to the example above where some users in an environment may perform an “access denied” error event, the anomaly detection system in some embodiments can analyze a pattern of the user behavior of “access denied” events rather than relying on a static rule, and from the analysis the system can determine that a user performs this action frequently, and does not generate an alert.

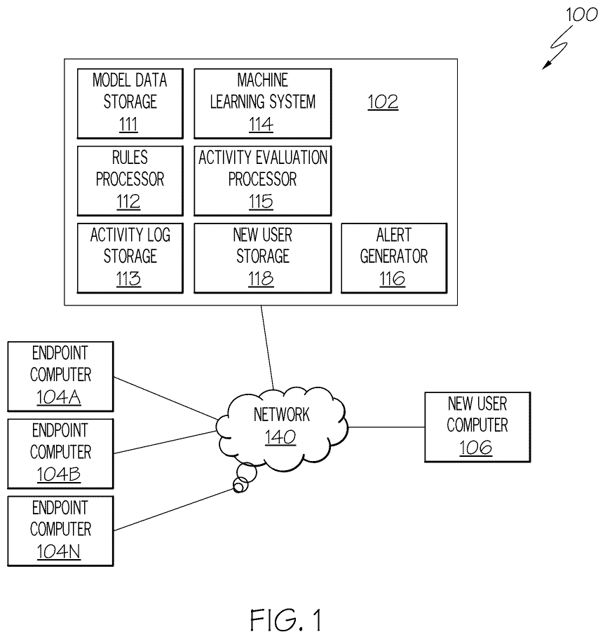

Referring now to the drawings, FIG. 1 depicts a block diagram of a computing environment 100 that includes an anomaly detection system 102, in accordance with an example embodiment. A plurality of endpoint computers 104A-104N (generally, 104), where N is an integer greater than 1, are connected to a network 140. The endpoint computers 104 can be referred to as “endpoints” and can also be categorized as electronic devices. At least one new user computer 106 may be connected to the network 140, and operated by a cold start user, although cold start users may alternatively operate an endpoint computer 104. The endpoints 104 connecting to the anomaly detection system 102 via the network 140 may be any type of electronic device known in the art, such as a personal computer, a laptop computer, a desktop computer, a surface computer, a mobile device, an internet of things (IoT) device, or the like.

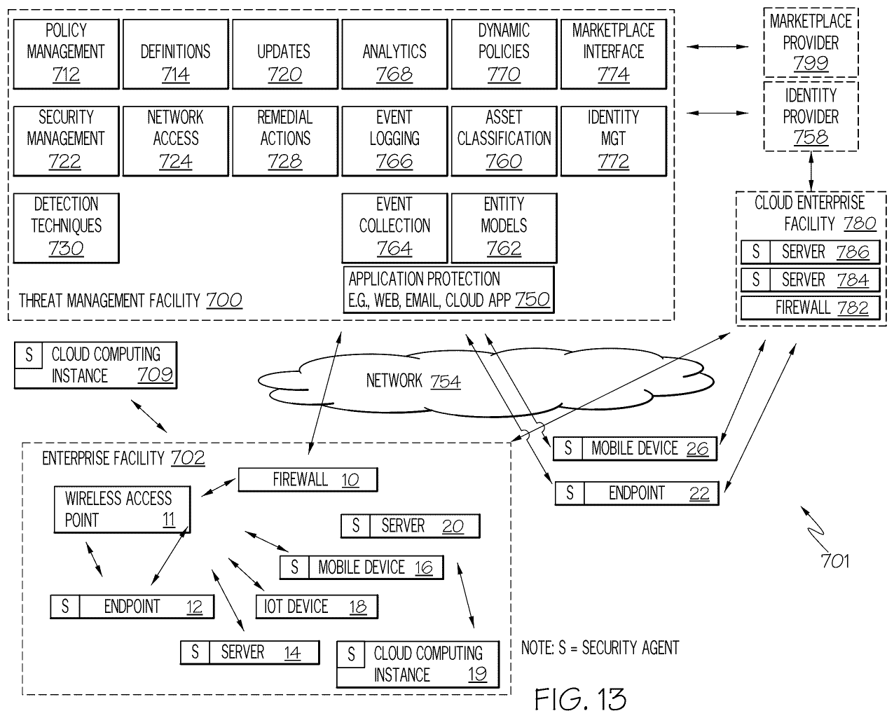

The network 140 may be an enterprise system, client system or any other type of network which might be monitored by the anomaly detection system 102. The endpoints 104, new user computers 106, and network 140 may be similar to the endpoints 12, 22, 16, 26, and network 754 in FIG. 13 and described below. The anomaly detection system 102 may be a computer system and/or cloud service system that is part of the threat management facility 700 of FIG. 13, which is connectable to the network 754 of FIG. 13 or the network 140 of FIG. 1.

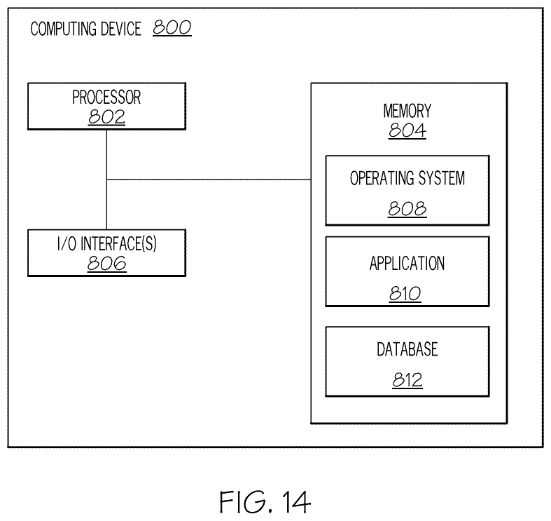

The anomaly detection system 102 may include a model data storage 111, a rules processor 112, an activity log storage 113, a machine learning system 114, an activity evaluation processor 115, an alert generator 116, and a new user storage 118. Some or all of these components of the anomaly detection system 102 may be software modules that are stored at and executed by one or more hardware processors. Some or all of these components of the anomaly detection system 102, individually or in any combination, may be provided by a computing system of the threat management facility 700 of FIG. 13 or computing device 800 of FIG. 14 and may be physically hosted by an enterprise, hosted in a cloud-based computing environment, or some combination of these, and may be available to network administrators or the like in a security operation center or other monitoring facility.

The model data storage 111 stores an account level behavior model, which may change over time as new computer users are added to an account in a cloud computing environment. The model data storage 111 may also store a custom anomaly detection model trained using the users' activity data. The model data storage 111 also stores model parameters generated in a training phase performed by the machine learning system 114 where an account level behavior model is trained using past activity patterns on an account level. Model parameters may include, but not be limited to, components within the model learned or estimated from the data during training. In some embodiments, these are the statistical quantities that define the shape and properties of the assumed distribution of the dataset. For example, model parameters that are learned during training could be the average number of error actions by the user in a cloud environment and its corresponding variance.

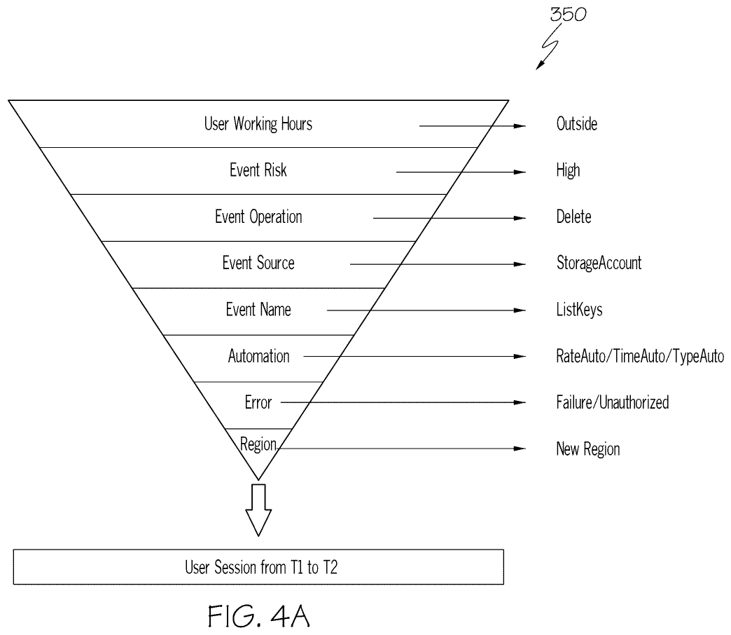

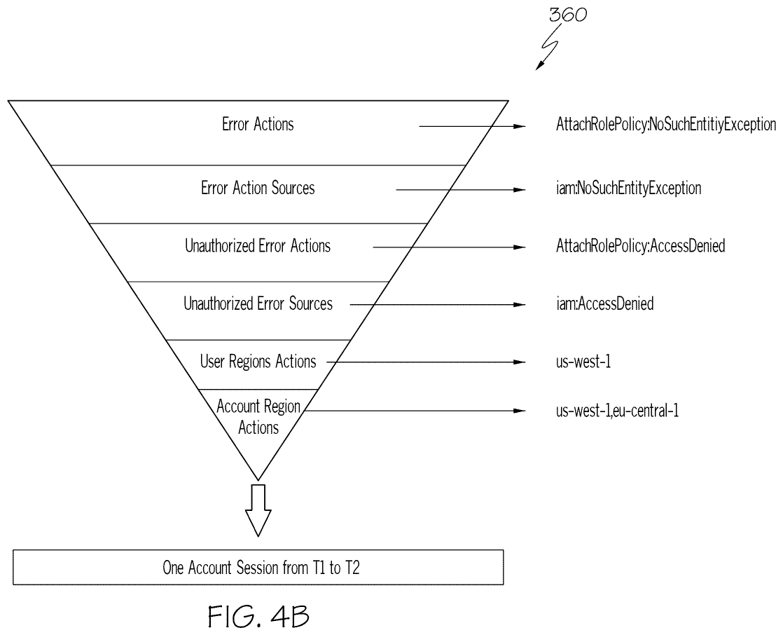

Past activity data may include, but not be limited to, account region activity, user region activity, error action activity, error source activity, unauthorized action activity, unauthorized source activity, and so on of all the existing users in the account. Account region activity may refer to the aggregated activity, or actions, performed by all active users in a cloud environment, for example, an account in each cloud region. For example: User X and User Y are members of Account A, and perform actions in cloud region R1 and R2. User region activity may be similar to account Region activity but different in that it is defined for a particular user instead of all users in an account. Referring again to the previous example, User X here performs actions in both cloud regions R1 and R2. Error action activity may include actions performed by a user in a cloud environment that results in an error. Errors can be of multiple types like Access Denied, Unauthorized, IncompleteSignature, InvalidAction, etc. For example: A user attempting to delete a storage unit in a cloud environment but does not have delete permission will produce an access denied error. Each action is considered separately. Error source activity may include a source/service corresponding to the actions resulting in an error. This includes all types of errors. Each action in a cloud environment corresponds to a unique service. One service can have multiple actions. For example, a user attempting to delete a storage unit in cloud environments but does not have delete permission will produce an access denied error. Then the user tries to create a storage unit which also produces an access denied error due to lack of permissions. Both actions (creating a storage unit and deleting a storage unit) belong to the same storage service and both of them will be included in the error source activity. As illustrated in FIG. 4B, unauthorized action activity is similar to error action activity but only those actions are considered which produce an access denied or unauthorized error i.e., errors produced due to lack of permissions. Unauthorized source activity is similar to error source activity but here only those sources are considered, actions belonging to which produced an access denied or Unauthorized error i.e., errors produced due to lack of permissions.

The rules processor 112 can process predefined rules that can be applied to an evaluation of activity performed by cold start users. Accordingly, the activity evaluation processor 115 can analyze activity performed by the cold start users and evaluate it through the model parameters learned in the training phase and also against the predefined rules provided by the rules processor 112. The anomaly detection system 102 does not rely solely on hard-coded rules or thresholds, but instead flags anomalies for users if their behavior deviates from a baseline account behavior. However, as described herein in some embodiments, rule-based anomaly detection may be combined with an average user behavior model to identify unusual patterns in data. An example of combining a rule and model may include a credit card company that institutes a rule that alerts are to be generated if a customer uses a credit card to purchase items greater than a predetermined value. The average user behavior model may establish that the customers, on average, purchase items greater than the predetermined value during the holiday season. This example, the credit card company, is not domain specific while the rules processor 112 can also process domain-specific rules. The rules processor 112 may nevertheless execute a probabilistic approach, e.g., using an average user behavior model that combines both behavior-based detections and rule-based detections to not only flag anomalies but also explain to the end user why the detections were flagged as anomalous in a straightforward language. For example, the anomaly detection system 102 can combine the average user baseline behavior model and at least one predefined rule to an activity performed by a cold start user, illustrated by examples herein. Referring to the previous example, during a normal season, the rule may be beneficial, but if only rules are available to flag alerts, then false positive results may occur during the holiday season. The same is mitigated using the average user behavior model and thereby resulting in better alerts.

The activity log storage 113 can store and process historical logging events, or actions, from a cloud environment, which can be used to learn users' past activity patterns and flag any potentially suspicious patterns when a user's current activity deviates from their past behavior (normal). Although a cold start user may lack historical data from which to derive past activity patterns, over time the cold start user may perform computer actions, and data from these actions can be received by the activity log storage 113.

The machine learning system 114 is constructed and arranged to train one or more account level behavior models, which may include cold start models, stored and processed at the model data storage 111 using past activity patterns stored at the activity log storage 113. In some embodiments, the machine learning system 114 can retrain a model by adding the recent activity done by all users in the training data. This retraining process keeps the models up to date with users' recent behavior. Over time, as more data becomes available for cold start users, they are evaluated through a custom anomaly detection model that is trained for them using only their own activity data instead of account level behavior model that is trained by averaging the activity across all users in the account. For example, a custom anomaly detection model for a user can be trained only if there is sufficient data, for example, data gathered over 10 days, available for a user. Until this much data becomes available, the user is treated as a cold start user and the account level model is used. Once this much or more data becomes available for this user over time, it ceases to exist as a cold start user and a custom anomaly detection model is trained for it.

The activity evaluation processor 115 is constructed and arranged to analyze activity-related information performed by cold start users and by way of the model parameters learned in the training phase and also against the predefined rules. Over time, as more data becomes available for cold start users, they are evaluated through a custom anomaly detection model that is trained for them using only their own activity data instead of account level behavior model that is trained by averaging the activity across all users in the account. For example, the activity evaluation processor 115 may determine that the users of an account perform, on average, five (5) file downloads per day. The alert generator 116 can communicate with the activity evaluation processor 115 and machine learning system 114 to generate alerts from detected anomalous user behavior, for example, when a user performs twenty (20) file downloads on a given day. A generated alert may include an activation of an indicator such as a message displayed on the user interface of the endpoint computer, an audio alarm, or a tactile motion of the endpoint computer such as a vibration.

The new user storage 118 may store and process cold start user activity data, which can be combined with historical activity data from other users of an account that is captured, stored, and logged for training or retraining by the machine learning system 114. Examples of activity data may include a number of unauthorized actions performed for a particular source/service. Here, a cold start user's number of attempted actions to a source that resulted in an unauthorized error may be abnormally high as compared to the historical activity data, which may include number of attempted actions to a source that resulted in unauthorized error by the other users in the account.

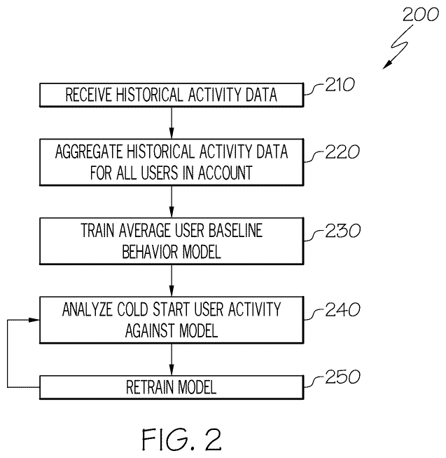

FIG. 2 depicts a method 200 for activity anomaly detection, in accordance with an example embodiment. The method 200 may be performed at the computing environment 100 of FIG. 1 above, or a threat management facility 700 described with reference to FIG. 13 below.

At step 210, historical activity data is received and collected by the activity log storage 113. In some embodiments, the historical activity data is received by one or more processors of the anomaly detection system 102. The historical activity data can be derived from endpoint computer users who are grouped into an account. One account may therefore include multiple users. In some embodiments, the activity log storage 113 may communicate with an event logging facility 766 in FIG. 13 to receive the historical activity data. Here, one or more of the activity log storage 113, machine learning system 114, and activity evaluation processor 115 can analyze historical logging events from cloud environments to learn users' past activity patterns. In some embodiments, the past activity patterns include activity patterns of all users of a particular account.

At step 220, the data collected in step 210 is processed and aggregated for all users in the account to construct features that are indicative of historical activity patterns on an account level, account region activity, user region activity, error action activity, error source activity, unauthorized action activity, unauthorized source activity etc.). These features constructed for all users are then averaged across to get features indicative of average user behavior in the account.

At step 230, a baseline or average user model of the account, also referred to as an average user baseline behavior model, is trained from the past activity data. More specifically, the anomaly detection system 102 trains an average user baseline behavior model for the account from the historical activity patterns. The model learns how an average user behaves in the account. The historical activity patterns of the other users in the same account as the cold start user can serve as a standard for, i.e., benchmark, for which the activity from cold start users can be measured so that anomalies in the cold start user activity can be flagged based on deviations from the baseline normal user behavior. In some embodiments, the anomaly detection system 102 learns a plurality of anomaly detection model parameters from the average user baseline behavior model.

Accordingly, at step 240, cold start user activity can be analyzed in view of the model. At this time, anomalies can be detected by applying the cold start user activity to the average user baseline behavior model. Over time, as more data becomes available for cold start users, they are evaluated through a custom anomaly detection model that is trained for them using only their own activity data instead of account level behavior model, also referred to an average user behavior model, that is trained by averaging the computer activity across all users in the given account. As more data becomes available for cold start users, new users can transition from a cold-start model to a custom anomaly detection model which is trained using their own activity data only. In some embodiments, the anomaly detection system applies the anomaly detection model parameters to a cold start user activity.

At step 250, after analyzing activity done by the cold start users and evaluating it through the model parameters learned in the training phase and optionally against the predefined rules, the model is retrained by adding the recent activity done by all users, including the cold start users, to the training data. This retraining process keeps the models up to date with users' recent behavior. Over time, as more data becomes available for cold start users, they are evaluated through a custom anomaly detection model that is trained for them using only their own activity data instead of account level behavior model that is trained by averaging the activity across all users in the account to determine average user behavior features in the account.

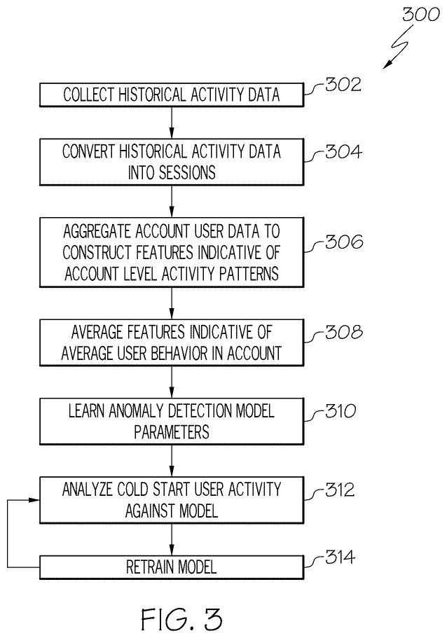

FIG. 3 depicts a method 300 for cold start user activity anomaly detection that includes behavior-based detections, in accordance with an example embodiment. The method 300 may be performed at the computing environment 100 of FIG. 1 above, or a threat management facility 700, which is described with reference to FIG. 13 below.

At step 302, historical activity data is collected. Here, the activity evaluation processor 115 can analyze the historical activity patterns collected by the activity log storage 113 such as historical logging events from cloud environments to learn users' past activity patterns. As previously described, the historical activity patterns include activity patterns of all users of a particular account. The anomaly detection system 102 can analyze the logging events of the historical activity data to learn historical activity patterns for the users in the account.

At step 304, the historical activity of one or more users in a predetermined account is converted into dynamically generated sessions, referred to as user activity sessions. In one embodiment, the one or more users includes all users in the predetermined account. In another embodiment, the number of users may be less than all users. This data may be stored in the activity log storage 113 of FIG. 1. A user activity session may be a series of actions or time ordered sequence of events by a user with sufficient proximity to imply they are part of the same activity such that one or more actions performed during this period are evaluated together while the system searches for anomalous behavior. In one embodiment, the one or more actions include all actions performed during this period. Each session can be time-sensitive and pertain to a given time period. The one or more actions performed during this time period can be evaluated together under the session for detecting possible anomalous behavior. For example, a user activity session can span a full day (e.g., 24 hours) on an account level during a training phase, i.e., where the machine learning system 114 learns detection model parameters using features indicative of past activity patterns at an account level, e.g., region activity, error-related activity, etc. The conversion of captured user activity into sessions is performed in order to learn and establish a baseline behavior at an account level, or an average user baseline behavior.

An anomalous condition can be detected based on predetermined user activity session criteria. For example, a user may establish as a criterion that for a given session, an anomalous condition may be detected if two consecutive events belong to the same session if the time difference between them is less than 8 hours. Another criterion may establish that an anomalous condition may be detected if a session greater than 15 hours. If either criterion is false, then the system 102 considers a new session to be started. A training snapshot for a user according to a predetermined training period can include multiple user activity sessions, for example, data collected over a period of three months and divided into the sessions, where each session satisfies the criteria. In some embodiments, a user activity session can span a full day on an account level, i.e. all users in a given account, during a training phase. In other embodiments, for a custom user model, a session is no longer than 15 hours and any two events in a given session are no more than 8 hours apart. The training snapshot of captured user activity therefore permits both time context user session data and event sequence data to be input into the model.

FIG. 4A depicts a diagram 350 illustrating examples of custom user model inputs for a user session between a first time (T1) and a second time (T2). In particular, the diagram 350 illustrates various event data of a session that can be used by the model to distinguish anomalous behavior from normal user behavior in a computing environment. For example, as shown, for the session, the data establishes that the user during the session operated outside user working hours, that the user performed a delete function, and that this is a high risk event, and that these actions performed between the first time (T1) and second time (T2) may be possible anomalous behavior.

FIG. 4B depicts a diagram 360 illustrating examples of account/cold start model inputs for an account session, in accordance with an example embodiment. Cold start models may rely on region and error activity-based features shown in FIG. 4B such as error action activity, error source activity, unauthorized action activity, unauthorized source activity, user region activity, and account region activity. For example, an unauthorized error action may include an activity (e.g., an “AttachRolePolicy” activity) for which an error (e.g., an “AccessDenied” error) is raised, which may contribute to anomalous behavior. This activity performed between the first time (T1) and second time (T2) may indicate possible anomalous behavior during this time period, for example, users in the account performing an anomalous amount of actions resulting in error.

Referring again to FIG. 3, at step 306 of method 300, data is processed and aggregated for all users in the account to construct features that are indicative of past activity patterns on an account level, e.g., account region activity, user region activity, error action activity, error source activity, unauthorized action activity, unauthorized source activity, etc.

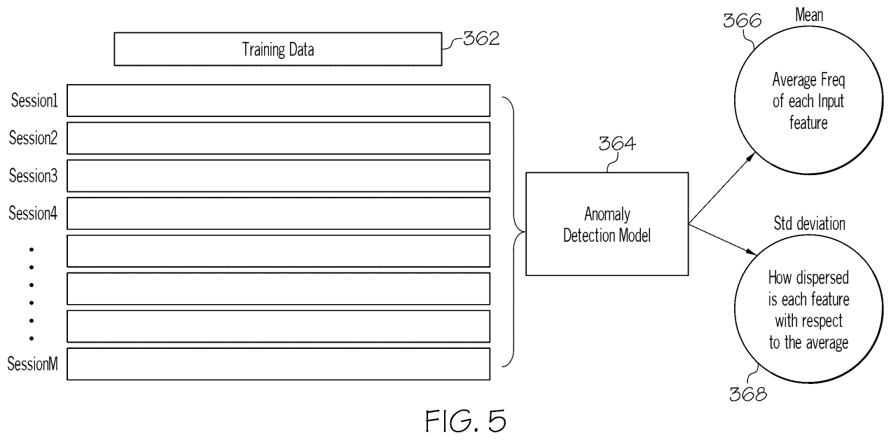

At step 308, these features constructed for the one or more users are then averaged across to determine features indicative of average user behavior in the account. As shown in FIG. 5, the training data 362 may include a plurality of sessions for each user, for example, described in step 304 for input to an anomaly detection model 364. The anomaly detection model 364 may be part of the average user baseline behavior model and stored at the model data storage 111 shown in FIG. 1. In some embodiments, the anomaly detection model 364 is a Gaussian anomaly detection model. The model 364 can learn an average user normal behavior from the historical data of the training data 362 by determining the average, or mean, frequency 366 of each of the session features. The model 364 can also determine a standard deviation 368, or an amount of dispersion of each feature with respect to the normal user behavior.

At step 310, anomaly detection model parameters are learned using the average features and a threshold is defined for flagging possible anomalies with respect to the features constructed during an evaluation phase during which anomalous behavior is determined to be present in the training data.

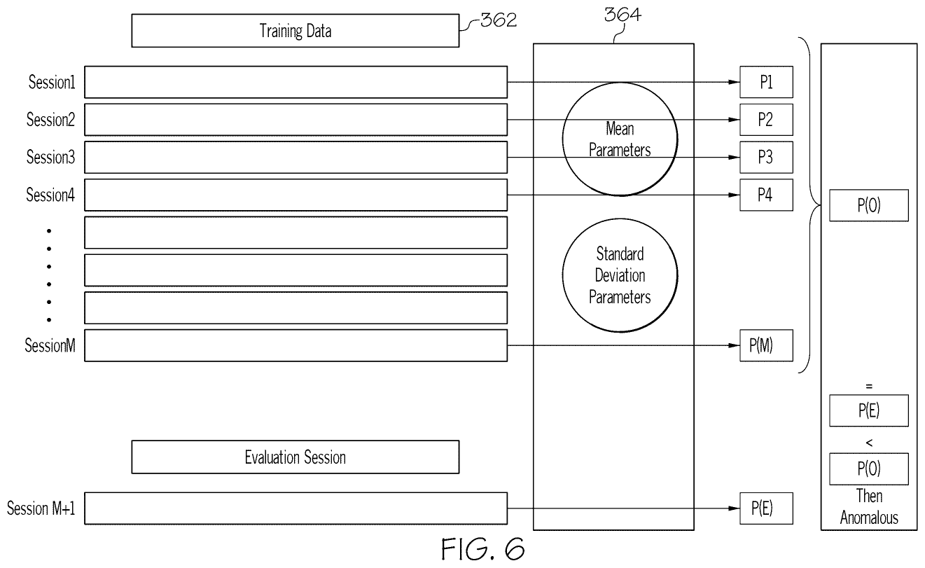

For example, as shown in FIG. 6, a threshold is defined from the determined mean and standard deviation of the input features derived in step 308 and is used when benchmarking a new user session M+1 during the evaluation phase. In one embodiment, the threshold P0 is determined from the probabilities P1-P(M) corresponding to the sessions 1-M of the training data 362 used by the anomaly detection model 364.

At step 312, activity performed by the cold start users is analyzed and evaluated through the model parameters P1-P(M) learned in the training phase and optionally also against predefined rules, for example, described above. This can be performed on a predetermined basis, for example, daily. Referring again to FIG. 6, a probability P(E) of a user session (e.g, session M+1) occurring with respect to the learned average user baseline behavior is provided in response to the analysis of cold start user activity. In one embodiment, where the probability P(E) is less than the probabilistic threshold P(0), the system determines that the cold start user behavior has deviated from average user behavior in the account and, thus, an anomaly is flagged.

When the evaluation phase is completed, the model is retrained at step 314 by adding the recent activity done by all users to the training data. Retraining the model is technologically beneficial because it ensures that the model is current with users' recent behavior. Over time, as more data becomes available for cold start users, they are evaluated through a custom anomaly detection model that is trained for them using only their own activity data instead of account level behavior model that is trained by averaging the activity across the one or more users in the account.

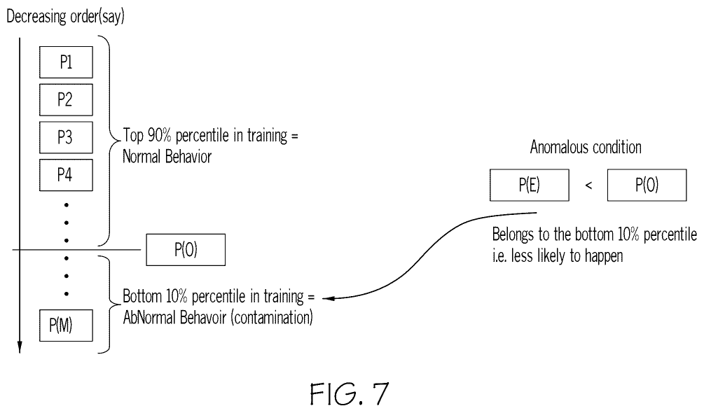

Referring to FIG. 7, to define a threshold, a contamination of some sessions is considered during the training phase. In this example, 10% of the user sessions during the training phase are considered contaminated or belonging to the bottom 10% percentile of the training data based on the probability found using the learned model parameters. This helps in identifying a probability threshold P(0) which separates the normal uncontaminated sessions and the abnormal contaminated sessions in the training snapshot. During the evaluation of session M+1 with probability P(E) not part of training data, if P(E) is less than threshold P(0), it implies that this session belongs to the bottom 10 percentile and hence anomalous. In other embodiments, different percentages may be considered and/or defined, for example, five percent, twenty-five percent, fifteen percent, and so forth.

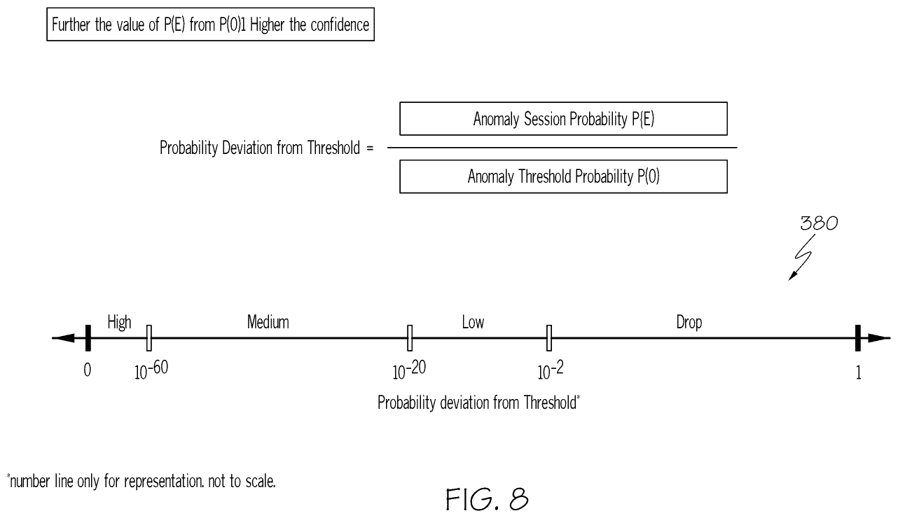

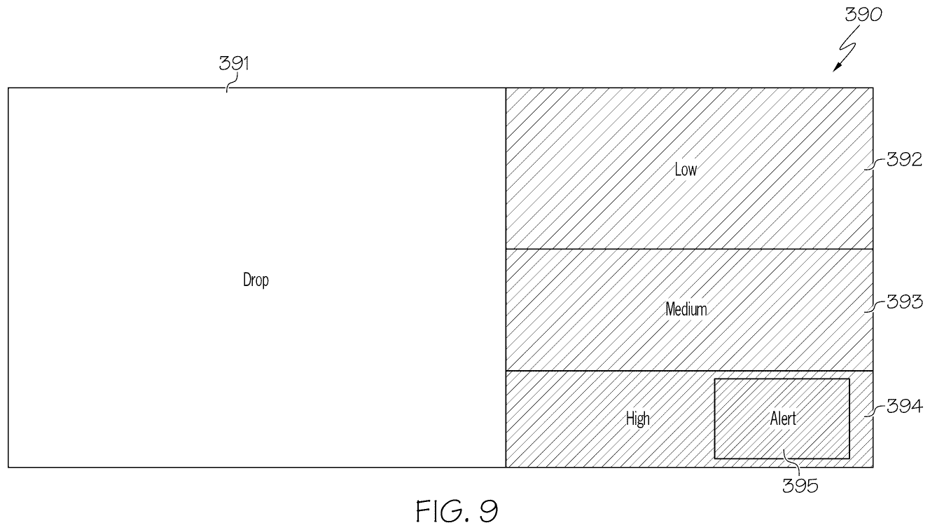

FIG. 8 depicts a diagram of a probability line 380 for categorizing computer user activity anomalies, in accordance with an example embodiment. As described above, if the probability P(E) is less than the threshold P(0), then the cold start user behavior has deviated from average user behavior in the account and an anomaly is flagged. However, since many anomalies may be flagged, it is also desirable to categorize the anomalies. In some embodiments, as shown in FIG. 9, a set of confidence buckets 390 can be generated to permit a user to prioritize which anomalies to investigate when analyzing computer user activity. In some embodiments, the confidence buckets can be categorized as low 392, medium 393, and high 394 buckets. A probability deviation may be calculated to determine a deviation value indicating how far a particular session probability P(E) is from the threshold P(0). Here, the probability deviation may be a ratio of the probability P(E) and threshold P(0). In the example shown in FIGS. 8 and 9, a probability deviation between 10⁻²⁰ and 10⁻² may be provided to the low confidence bucket 392. A probability deviation between 10⁻⁶⁰ and 10⁻²⁰ may be provided to the medium confidence bucket 393. A probability deviation between 0 and 10⁻⁶⁰ may be provided to the high confidence bucket 394. A probability deviation between 10⁻² and 1 indicates that the probability P(E) and threshold P(0) have the same or similar value, and that the flagged anomaly should be added to the drop bucket 391.

On the other end of the scale, a very high probability deviation may qualify as an alert, for example, executed by the alert generator 116 of FIG. 1. As shown in FIG. 9, some anomalies in the high confidence bucket 394, i.e., having a probability deviation between 0 and 1060, may qualify as alerts. Accordingly, the high confidence bucket 394 may be further categorized into a sub-bucket 395 where anomalies are identified as alerts and a sub-bucket 394 where anomalies are not identified as alerts. Alerts may be identified by user-defined criteria. For example, in environments where the system detects substantial anomalous user behavior, a user may desire to permit alerts to be generated for only a fraction of the number of anomalies in the high confidence bucket, for example, a user-defined value of 20%.

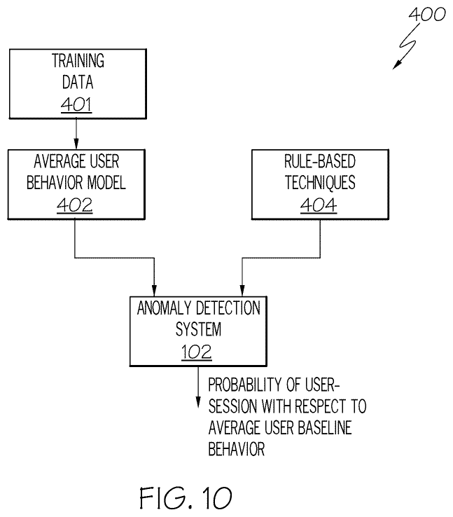

FIG. 10 depicts an anomaly detection architecture 400, in accordance with an example embodiment.

The architecture 400 includes the anomaly detection system 102 of FIG. 1, which can combine an account level behavior model, referred to as an average user behavior model 402 with one or more well-known rule-based approaches 404, thus reducing false positives and also leading to better detections. The anomaly detection architecture 400 allows administrators or the like to have a Day 0 visibility into anomalous activity done by cold start users. This is because the anomaly detection system 102 can analyze activity done by the cold start users and evaluate it through the model parameters learned in a training phase performed by the machine learning system 114 and also against the predefined rules provided by the rules processor 112 that can implement the rule-based approaches 404. The machine learning system 114 can reveal patterns in the user activity data.

The architecture 400 can address and overcome conventional problems where a rule-only approach 404 performs poorly in dynamic cloud environments for users with no/limited past logging data. Most cloud behavior anomaly detection systems use rule-based approaches to solve for little to no past activity data available for cold start users. While these rules are of value, using them alone leads to a high false positive rate.

The architecture in accordance with some embodiments can complement a rules-based approach 404 by leveraging past activity data of all the users in the account, averaging it and training the average user behavior model 402 using training data 401. This model 402, when executed by the anomaly detection system 102 learns how an average user behaves in the account and thus activity from cold start users could be benchmarked against this and deviations flagged. This approach uses various signals engineered from past activity data such as account region activity, user region activity, error action activity, error source activity unauthorized action activity, unauthorized source activity, and so on but not limited thereto, and combines them with one or more rule based approaches to assign a probability to each cold-start-user-activity in the cloud environment. This may reduce false positives and produce improved anomaly detections.

The architecture 400 can address and overcome another conventional problem where actions are evaluated in isolation. Here, actions done by cold start users in cloud environments are evaluated in isolation during security monitoring in rule-based approaches. However, when SOC's are investigating the anomalies, they need more context around the isolated actions.

To overcome this challenge, the architecture 400 relies on a modeled use case to find anomalies in cold-start-user-activity. A user activity can be defined as a user session from a first time to a second time, and all actions performed during this time period are evaluated together while looking for anomalous behavior.

The architecture 400 can address and overcome another conventional problem where a rules-based approach prevents changes from occurring with respect to cold start users even if enough data is available. Most rule-based approaches are static and the amount of historical data available has no effect on these approaches. Hence, these approaches do not get updated as user behavior evolves inside the cloud environment.

In some embodiments, cold-start activity anomaly detection models are continuously updated as users across the account perform new activity. Thus, all new behaviors are learned over time and unnecessary anomalies are not flagged. Over time, as more data becomes available for cold start users, users transition from a cold-start model to a custom anomaly detection model which is trained using their own activity data only, and does not rely on the activity data of other users.

Accordingly, advantages of the anomaly detection system 102 are that there are no hardcoded rules and thresholds. As described above, conventional solutions like one provided by a cloud computing environment itself focus on flagging actions in isolation or through hardcoded rule-based systems or hardcoded thresholds. Such solutions are prone to high levels of false positives and also do not mimic an actual attack scenario which is usually a sequence of events.

As described above, in some embodiments, once an account is active for a given time period, e.g., 2 months, any activity done by newly created users and roles, as well as for users who exhibit minimal activity within the cloud environment is evaluated from Day 0 itself in our approach. Conventional techniques typically skip evaluation for such users or have rule-based systems in place for them as there is not enough logging data to learn their activity patterns. However, in these embodiments, the anomaly detection system 102 achieves this by training an account level behavior model. This model can also be considered like an average user behavior model of that account. The system 102 can then flag anomalies for such users if their behavior deviates from baseline account behavior.

Conventional anomaly detection solutions treat anomaly detection models as a black box. Thus, the end user only gets to know if something is anomalous or not but not why it is anomalous. As shown in FIG. 10, in some embodiments, both behavior-based detections and rule-based detections are combined and processed to not only flag anomalies but also explain to the end user why it was flagged as anomalous in a straightforward language. An example of a rule combined with an average user behavior model may include region-related activity. In this example, several users in a cloud environment may perform activity in different regions, arranged as a first region set. The average user behavior model for these regions in the first region set can be learned from their past activity. However, regions may have no user activity, referred to as a second region set, so the average user behavior model cannot learn anything for these regions as there is no historical data corresponding to any user in the account. Therefore, to evaluate new activity done by a cold start user in a region, the average user behavior model may be used if the region belongs to the first region set and a rule-based approach is applied if a region belongs to the second region set. An example rule may be to flag a new resource created by a cold start user in the second region set. The absence of a rules engine in place for regions in the second region set may cause any activity performed by a user in these regions to be ignored or skipped over, and thereby an adversary could enter the system without raising any alerts. And if only rules were used for the first region set instead of the average user behavior model, significant numbers of false positives may appear. Therefore, the combination assists in reducing the number of false positives and also ensures that no activity in any region is missed in an evaluation.

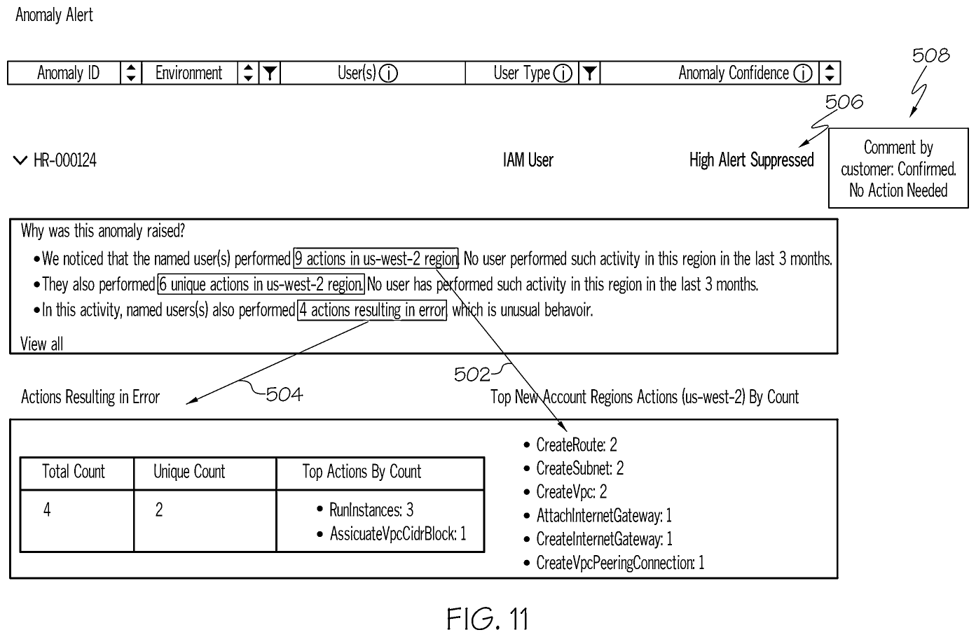

FIG. 11 depicts a screenshot of an anomaly alert displayed at a computer display, in accordance with an example embodiment. In FIG. 11, a user performs computer activity in a region where previously no activity was seen in the entire account. New resources are created in the region, and error events are produced. Adversaries generally try to use a region with low activity to evade the security radar. The anomaly detection system 102 flags the anomalous behavior which may be verified by an administrator, for example, a security operations center (SOC), who can subsequently suppress the alert after verification. The displayed alert may include information such as actions 502 performed by the user, actions resulting in error 504, and an indicator 506 stating that the current alert is suppressed. A comment field 508 may be provided that permits the user to insert a comment, for example, confirming the suppression of the alert.

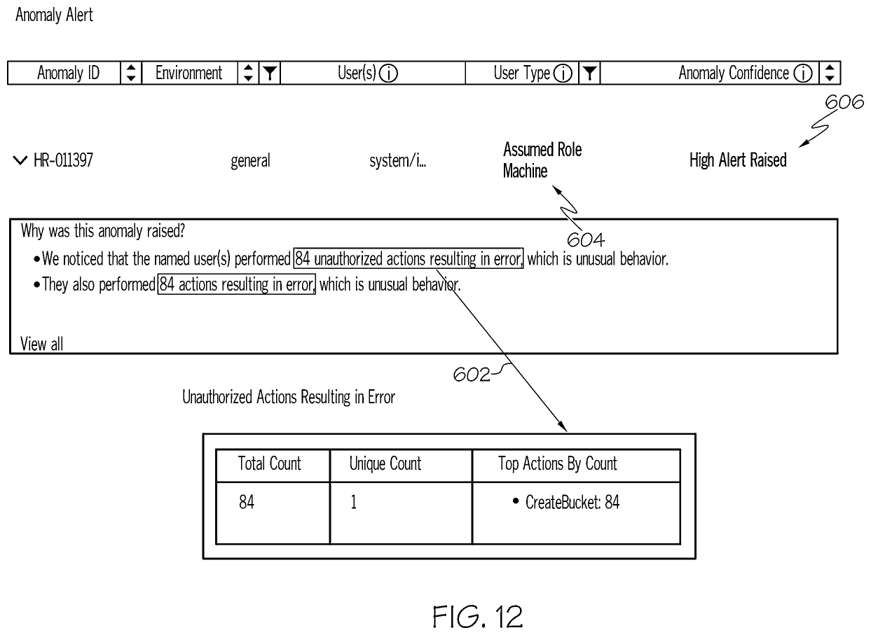

FIG. 12 depicts a screenshot of an alert displayed at a computer display, in accordance with another example embodiment. Here, the displayed alert is the result of an anomaly detection operation detecting a misconfiguration in a cloud computing environment. In FIG. 12, the displayed alert identifies a computer instance, or machine 604, that has executed actions, such as creating buckets, resulting in error due to lack of permissions. The displayed alert includes an indicator 606 that an alert is generated when the computer fails to create buckets, which is indicative of unusual behavior. The displayed alert may include information 602 such as details about the raised anomaly and the unauthorized actions.

FIG. 13 depicts a block diagram of a threat management facility 700 providing protection against a plurality of threats, such as malware, viruses, spyware, cryptoware, adware, Trojans, spam, intrusion, policy abuse, improper configuration, vulnerabilities, improper access, uncontrolled access, code injection attacks and more according to an example embodiment. The threat management facility 700 may be used for performing anomaly detection operations in accordance with the method 200 of FIG. 2 and method 300 of FIG. 3. Accordingly, elements of the threat management facility 700 may be similar to or the same as the computing environment 100 of FIG. 1.

The threat management facility 700 may communicate with, coordinate, and control operation of security functionality at different control points, layers, and levels within the facility 700. A number of capabilities may be provided by the threat management facility 700, with an overall goal to intelligently use the breadth and depth of information that is available about the operation and activity of compute instances and networks as well as a variety of available controls. Another overall goal is to provide protection needed by an organization that is dynamic and able to adapt to changes in compute instances and new threats or unwanted activity. In embodiments, the threat management facility 700 may provide protection from a variety of threats or unwanted activity to an enterprise facility that may include a variety of compute instances in a variety of locations and network configurations.

Just as one example, users of the threat management facility 700 may define and enforce policies that control access to and use of compute instances, networks and data. Administrators may update policies such as by designating authorized users and conditions for use and access. The threat management facility 700 may update and enforce those policies at various levels of control that are available, such as by directing compute instances to control the network traffic that is allowed to traverse firewalls and wireless access points, applications and data available from servers, applications and data permitted to be accessed by endpoints, and network resources and data permitted to be run and used by endpoints. The threat management facility 700 may provide many different services, and policy management may be offered as one of the services.

Turning to a description of certain capabilities and components of the threat management facility 700, an exemplary enterprise facility 702 may be or may include any networked computer-based infrastructure. For example, the enterprise facility 702 may be corporate, commercial, organizational, educational, governmental, or the like. As home networks get more complicated and include more compute instances at home and in the cloud, an enterprise facility 702 may also or instead include a personal network such as a home or a group of homes. The enterprise facility's 702 computer network may be distributed amongst a plurality of physical premises such as buildings on a campus, and located in one or in a plurality of geographical locations. The configuration of the enterprise facility as shown is merely exemplary, and it will be understood that there may be any number of compute instances, less or more of each type of compute instance, and other types of compute instances. As shown, the exemplary enterprise facility includes a firewall 10, a wireless access point 11, an endpoint 12, a server 14, a mobile device 16, an appliance or IoT device 18, a cloud computing instance 19, and a server 20. Again, the compute instances 10-20 depicted are exemplary, and there may be any number or type of compute instances 10-20 in a given enterprise facility. For example, in addition to the elements depicted in the enterprise facility 702, there may be one or more gateways, bridges, wired networks, wireless networks, virtual private networks, other compute instances, and so on.

The threat management facility 700 may include certain facilities, such as a policy management facility 712, security management facility 722, update facility 720, definitions facility 714, network access rules facility 724, remedial action facility 728, detection techniques facility 730, application protection facility 750, asset classification facility 760, entity model facility 762, event collection facility 764, event logging facility 766, analytics facility 768, dynamic policies facility 770, identity management facility 772, and marketplace management facility 774, as well as other facilities. For example, there may be a testing facility, a threat research facility, and other facilities. It should be understood that the threat management facility 700 may be implemented in whole or in part on a number of different compute instances, with some parts of the threat management facility on different compute instances in different locations. For example, some or all of one or more of the various facilities 700, 712-774 may be provided as part of a security agent S that is included in software running on a compute instance 10-26 within the enterprise facility. Some or all of one or more of the facilities 700, 712-774 may be provided on the same physical hardware or logical resource as a gateway, such as a firewall 10, or wireless access point 11. Some or all of one or more of the facilities may be provided on one or more cloud servers that are operated by the enterprise or by a security service provider, such as the cloud computing instance 709.

In embodiments, a marketplace provider 799 may make available one or more additional facilities to the enterprise facility 702 via the threat management facility 700. The marketplace provider may communicate with the threat management facility 700 via the marketplace interface facility 774 to provide additional functionality or capabilities to the threat management facility 700 and compute instances 10-26. A marketplace provider 799 may be selected from a number of providers in a marketplace of providers that are available for integration or collaboration via the marketplace interface facility 774. A given marketplace provider 799 may use the marketplace interface facility 774 even if not engaged or enabled from or in a marketplace. As non-limiting examples, the marketplace provider 799 may be a third-party information provider, such as a physical security event provider; the marketplace provider 799 may be a system provider, such as a human resources system provider or a fraud detection system provider; the marketplace provider 799 may be a specialized analytics provider; and so on. The marketplace provider 799, with appropriate permissions and authorization, may receive and send events, observations, inferences, controls, convictions, policy violations, or other information to the threat management facility. For example, the marketplace provider 799 may subscribe to and receive certain events, and in response, based on the received events and other events available to the marketplace provider 799, send inferences to the marketplace interface, and in turn to the analytics facility 768, which in turn may be used by the security management facility 722.

The identity provider 758 may be any remote identity management system or the like configured to communicate with an identity management facility 772, e.g., to confirm identity of a user as well as provide or receive other information about users that may be useful to protect against threats. In general, the identity provider may be any system or entity that creates, maintains, and manages identity information for principals while providing authentication services to relying party applications, e.g., within a federation or distributed network. The identity provider may, for example, offer user authentication as a service, where other applications, such as web applications, outsource the user authentication step to a trusted identity provider.

In embodiments, the identity provider 758 may provide user identity information, such as multi-factor authentication, to a SaaS application. Centralized identity providers such as Microsoft Azure, may be used by an enterprise facility instead of maintaining separate identity information for each application or group of applications, and as a centralized point for integrating multifactor authentication. In embodiments, the identity management facility 772 may communicate hygiene, or security risk information, to the identity provider 758. The identity management facility 772 may determine a risk score for a user based on the events, observations, and inferences about that user and the compute instances associated with the user. If a user is perceived as risky, the identity management facility 772 can inform the identity provider 758, and the identity provider 758 may take steps to address the potential risk, such as to confirm the identity of the user, confirm that the user has approved the SaaS application access, remediate the user's system, or such other steps as may be useful.

In embodiments, threat protection provided by the threat management facility 700 may extend beyond the network boundaries of the enterprise facility 702 to include clients (or client facilities) such as an endpoint 22 outside the enterprise facility 702, a mobile device 26, a cloud computing instance 709, or any other devices, services or the like that use network connectivity not directly associated with or controlled by the enterprise facility 702, such as a mobile network, a public cloud network, or a wireless network at a hotel or coffee shop. While threats may come from a variety of sources, such as from network threats, physical proximity threats, secondary location threats, the compute instances 10-26 may be protected from threats even when a compute instance 10-26 is not connected to the enterprise facility 702 network, such as when compute instances 22, 26 use a network that is outside of the enterprise facility 702 and separated from the enterprise facility 702, e.g., by a gateway, a public network, and so forth.

In some implementations, compute instances 10-26 may communicate with a cloud enterprise facility 780. The cloud enterprise facility may include one or more cloud applications, such as a SaaS application, which is used by but not operated by the enterprise facility 702. Exemplary commercially available SaaS applications include Salesforce, Amazon Web Services (AWS) applications, Google Apps applications, Microsoft Office 365 applications and so on. A given SaaS application may communicate with an identity provider 758 to verify user identity consistent with the requirements of the enterprise facility 702. The compute instances 10-26 may communicate with an unprotected server (not shown) such as a web site or a third-party application through an internetwork 754 such as the Internet or any other public network, private network or combination of these.

The cloud enterprise facility 780 may include servers 784, 786, and a firewall 782. The servers 784, 786 on the cloud enterprise facility 780 may run one or more enterprise or cloud applications, such as SaaS applications, and make them available to the enterprise facilities 702 compute instances 10-26. It should be understood that there may be any number of servers 784, 786 and firewalls 782, as well as other compute instances in a given cloud enterprise facility 780. It also should be understood that a given enterprise facility may use both SaaS applications and cloud enterprise facilities 780, or, for example, a SaaS application may be deployed on a cloud enterprise facility 780.

In embodiments, aspects of the threat management facility 700 may be provided as a stand-alone solution. In other embodiments, aspects of the threat management facility 700 may be integrated into a third-party product. An application programming interface (e.g., a source code interface) may be provided such that aspects of the threat management facility 700 may be integrated into or used by or with other applications. For instance, the threat management facility 700 may be stand-alone in that it provides direct threat protection to an enterprise or computer resource, where protection is subscribed to directly. Alternatively, the threat management facility may offer protection indirectly, through a third-party product, where an enterprise may subscribe to services through the third-party product, and threat protection to the enterprise may be provided by the threat management facility 700 through the third-party product.

The security management facility 722 may provide protection from a variety of threats by providing, as non-limiting examples, endpoint security and control, email security and control, web security and control, reputation-based filtering, machine learning classification, control of unauthorized users, control of guest and non-compliant computers, and more.

The security management facility 722 may provide malicious code protection to a compute instance. The security management facility 722 may include functionality to scan applications, files, and data for malicious code, remove or quarantine applications and files, prevent certain actions, perform remedial actions, as well as other security measures. Scanning may use any of a variety of techniques, including without limitation signatures, identities, classifiers, and other suitable scanning techniques. In embodiments, the scanning may include scanning some or all files on a periodic basis, scanning an application when the application is executed, scanning data transmitted to or from a device, scanning in response to predetermined actions or combinations of actions, and so forth. The scanning of applications, files, and data may be performed to detect known or unknown malicious code or unwanted applications. Aspects of the malicious code protection may be provided, for example, in the security agent of an endpoint 12, in a wireless access point 11 or firewall 10, as part of application protection 750 provided by the cloud, and so on.

In an embodiment, the security management facility 722 may provide for email security and control, for example to target spam, viruses, spyware and phishing, to control email content, and the like. Email security and control may protect against inbound and outbound threats, protect email infrastructure, prevent data leakage, provide spam filtering, and more. Aspects of the email security and control may be provided, for example, in the security agent of an endpoint 12, in a wireless access point 11 or firewall 10, as part of application protection 750 provided by the cloud, and so on.

In an embodiment, security management facility 722 may provide for web security and control, for example, to detect or block viruses, spyware, malware, unwanted applications, help control web browsing, and the like, which may provide comprehensive web access control enabling safe, productive web browsing. Web security and control may provide Internet use policies, reporting on suspect compute instances, security and content filtering, active monitoring of network traffic, URI filtering, and the like. Aspects of the web security and control may be provided, for example, in the security agent of an endpoint 12, in a wireless access point 11 or firewall 10, as part of application protection 750 provided by the cloud, and so on.

In an embodiment, the security management facility 722 may provide for network access control, which generally controls access to and use of network connections. Network control may stop unauthorized, guest, or non-compliant systems from accessing networks, and may control network traffic that is not otherwise controlled at the client level. In addition, network access control may control access to virtual private networks (VPN), where VPNs may, for example, include communications networks tunneled through other networks and establishing logical connections acting as virtual networks. In embodiments, a VPN may be treated in the same manner as a physical network. Aspects of network access control may be provided, for example, in the security agent of an endpoint 12, in a wireless access point 11 or firewall 10, as part of application protection 750 provided by the cloud, e.g., from the threat management facility 700 or other network resource(s).

In an embodiment, the security management facility 722 may provide for host intrusion prevention through behavioral monitoring and/or runtime monitoring, which may guard against unknown threats by analyzing application behavior before or as an application runs. This may include monitoring code behavior, application programming interface calls made to libraries or to the operating system, or otherwise monitoring application activities. Monitored activities may include, for example, reading and writing to memory, reading and writing to disk, network communication, process interaction, and so on. Behavior and runtime monitoring may intervene if code is deemed to be acting in a manner that is suspicious or malicious. Aspects of behavior and runtime monitoring may be provided, for example, in the security agent of an endpoint 12, in a wireless access point 11 or firewall 10, as part of application protection 750 provided by the cloud, and so on.

In an embodiment, the security management facility 722 may provide for reputation filtering, which may target or identify sources of known malware. For instance, reputation filtering may include lists of URIs of known sources of malware or known suspicious IP addresses, code authors, code signers, or domains, that when detected may invoke an action by the threat management facility 700. Based on reputation, potential threat sources may be blocked, quarantined, restricted, monitored, or some combination of these, before an exchange of data can be made. Aspects of reputation filtering may be provided, for example, in the security agent of an endpoint 12, in a wireless access point 11 or firewall 10, as part of application protection 750 provided by the cloud, and so on. In embodiments, some reputation information may be stored on a compute instance 10-26, and other reputation data available through cloud lookups to an application protection lookup database, such as may be provided by application protection 750.

In embodiments, information may be sent from the enterprise facility 702 to a third party, such as a security vendor, or the like, which may lead to improved performance of the threat management facility 700. In general, feedback may be useful for any aspect of threat detection. For example, the types, times, and number of virus interactions that an enterprise facility 702 experiences may provide useful information for the prevention of future virus threats. Feedback may also be associated with behaviors of individuals within the enterprise, such as being associated with most common violations of policy, network access, unauthorized application loading, unauthorized external device use, and the like. In embodiments, feedback may enable the evaluation or profiling of client actions that are violations of policy that may provide a predictive model for the improvement of enterprise policies.

An update management facility 720 may provide control over when updates are performed. The updates may be automatically transmitted, manually transmitted, or some combination of these. Updates may include software, definitions, reputations or other code or data that may be useful to the various facilities. For example, the update facility 720 may manage receiving updates from a provider, distribution of updates to enterprise facility 702 networks and compute instances, or the like. In embodiments, updates may be provided to the enterprise facility's 702 network, where one or more compute instances on the enterprise facility's 702 network may distribute updates to other compute instances.

The threat management facility 700 may include a policy management facility 712 that manages rules or policies for the enterprise facility 702. Exemplary rules include access permissions associated with networks, applications, compute instances, users, content, data, and the like. The policy management facility 712 may use a database, a text file, other data store, or a combination to store policies. In an embodiment, a policy database may include a block list, a blacklist, an allowed list, a whitelist, and more. As a few non-limiting examples, policies may include a list of enterprise facility 702 external network locations/applications that may or may not be accessed by compute instances, a list of types/classifications of network locations or applications that may or may not be accessed by compute instances, and contextual rules to evaluate whether the lists apply. For example, there may be a rule that does not permit access to sporting websites. When a website is requested by the client facility, a security management facility 722 may access the rules within a policy facility to determine if the requested access is related to a sporting website.

The policy management facility 712 may include access rules and policies that are distributed to maintain control of access by the compute instances 10-26 to network resources. Exemplary policies may be defined for an enterprise facility, application type, subset of application capabilities, organization hierarchy, compute instance type, user type, network location, time of day, connection type, or any other suitable definition. Policies may be maintained through the threat management facility 700, in association with a third party, or the like. For example, a policy may restrict instant messaging (IM) activity by limiting such activity to support personnel when communicating with customers. More generally, this may allow communication for departments as necessary or helpful for department functions, but may otherwise preserve network bandwidth for other activities by restricting the use of IM to personnel that need access for a specific purpose. In an embodiment, the policy management facility 712 may be a stand-alone application, may be part of the network server facility 742, may be part of the enterprise facility 702 network, may be part of the client facility, or any suitable combination of these.

The policy management facility 712 may include dynamic policies that use contextual or other information to make security decisions. As described herein, the dynamic policies facility 770 may generate policies dynamically based on observations and inferences made by the analytics facility. The dynamic policies generated by the dynamic policy facility 770 may be provided by the policy management facility 712 to the security management facility 722 for enforcement.

In embodiments, the threat management facility 700 may provide configuration management as an aspect of the policy management facility 712, the security management facility 722, or some combination. Configuration management may define acceptable or required configurations for the compute instances 10-26, applications, operating systems, hardware, or other assets, and manage changes to these configurations. Assessment of a configuration may be made against standard configuration policies, detection of configuration changes, remediation of improper configurations, application of new configurations, and so on. An enterprise facility may have a set of standard configuration rules and policies for particular compute instances which may represent a desired state of the compute instance. For example, on a given compute instance 12, 14, 18, a version of a client firewall may be required to be running and installed. If the required version is installed but in a disabled state, the policy violation may prevent access to data or network resources. A remediation may be to enable the firewall. In another example, a configuration policy may disallow the use of USB disks, and policy management 712 may require a configuration that turns off USB drive access via a registry key of a compute instance. Aspects of configuration management may be provided, for example, in the security agent of an endpoint 12, in a wireless access point 11 or firewall 10, as part of application protection 750 provided by the cloud, or any combination of these.

In embodiments, the threat management facility 700 may also provide for the isolation or removal of certain applications that are not desired or may interfere with the operation of a compute instance 10-26 or the threat management facility 700, even if such application is not malware per se. The operation of such products may be considered a configuration violation. The removal of such products may be initiated automatically whenever such products are detected, or access to data and network resources may be restricted when they are installed and running. In the case where such applications are services which are provided indirectly through a third-party product, the applicable application or processes may be suspended until action is taken to remove or disable the third-party product.

The policy management facility 712 may also require update management (e.g., as provided by the update facility 720). Update management for the security facility 722 and policy management facility 712 may be provided directly by the threat management facility 700, or, for example, by a hosted system. In embodiments, the threat management facility 700 may also provide for patch management, where a patch may be an update to an operating system, an application, a system tool, or the like, where one of the reasons for the patch is to reduce vulnerability to threats.

In embodiments, the security facility 722 and policy management facility 712 may push information to the enterprise facility 702 network and/or the compute instances 10-26, the enterprise facility 702 network and/or compute instances 10-26 may pull information from the security facility 722 and policy management facility 712, or there may be a combination of pushing and pulling of information. For example, the enterprise facility 702 network and/or compute instances 10-26 may pull update information from the security facility 722 and policy management facility 712 via the update facility 720, an update request may be based on a time period, by a certain time, by a date, on demand, or the like. In another example, the security facility 722 and policy management facility 712 may push the information to the enterprise facility's 702 network and/or compute instances 10-26 by providing notification that there are updates available for download and/or transmitting the information. In an embodiment, the policy management facility 712 and the security facility 722 may work in concert with the update management facility 720 to provide information to the enterprise facility's 702 network and/or compute instances 10-26. In various embodiments, policy updates, security updates and other updates may be provided by the same or different modules, which may be the same or separate from a security agent running on one of the compute instances 10-26.

As threats are identified and characterized, the definition facility 714 of the threat management facility 700 may manage definitions used to detect and remediate threats. For example, identity definitions may be used for scanning files, applications, data streams, etc. for the determination of malicious code. Identity definitions may include instructions and data that can be parsed and acted upon for recognizing features of known or potentially malicious code. Definitions also may include, for example, code or data to be used in a classifier, such as a neural network or other classifier that may be trained using machine learning. Updated code or data may be used by the classifier to classify threats. In embodiments, the threat management facility 700 and the compute instances 10-26 may be provided with new definitions periodically to include most recent threats. Updating of definitions may be managed by the update facility 720, and may be performed upon request from one of the compute instances 10-26, upon a push, or some combination. Updates may be performed upon a time period, on demand from a device 10-26, upon determination of an important new definition or a number of definitions, and so on.

A threat research facility (not shown) may provide a continuously ongoing effort to maintain the threat protection capabilities of the threat management facility 700 in light of continuous generation of new or evolved forms of malware. Threat research may be provided by researchers and analysts working on known threats, in the form of policies, definitions, remedial actions, and so on.

The security management facility 722 may scan an outgoing file and verify that the outgoing file is permitted to be transmitted according to policies. By checking outgoing files, the security management facility 722 may be able discover threats that were not detected on one of the compute instances 10-26, or policy violation, such transmittal of information that should not be communicated unencrypted.

The threat management facility 700 may control access to the enterprise facility 702 networks. A network access facility 724 may restrict access to certain applications, networks, files, printers, servers, databases, and so on. In addition, the network access facility 724 may restrict user access under certain conditions, such as the user's location, usage history, need to know, job position, connection type, time of day, method of authentication, client-system configuration, or the like. Network access policies may be provided by the policy management facility 712, and may be developed by the enterprise facility 702, or pre-packaged by a supplier. Network access facility 724 may determine if a given compute instance 10-22 should be granted access to a requested network location, e.g., inside or outside of the enterprise facility 702. Network access facility 724 may determine if a compute instance 22, 26 such as a device outside the enterprise facility 702 may access the enterprise facility 702. For example, in some cases, the policies may require that when certain policy violations are detected, certain network access is denied. The network access facility 724 may communicate remedial actions that are necessary or helpful to bring a device back into compliance with policy as described below with respect to the remedial action facility 728. Aspects of the network access facility 724 may be provided, for example, in the security agent of the endpoint 12, in a wireless access point 11, in a firewall 10, as part of application protection 750 provided by the cloud.

In an embodiment, the network access facility 724 may have access to policies that include one or more of a block list, a denylist or blacklist, an allowed list, a whitelist, an unacceptable network site database, an acceptable network site database, a network site reputation database, or the like of network access locations that may or may not be accessed by the client facility. Additionally, the network access facility 724 may use rule evaluation to parse network access requests and apply policies. The network access rule facility 724 may have a generic set of policies for all compute instances, such as denying access to certain types of websites, controlling instant messenger accesses, or the like. Rule evaluation may include regular expression rule evaluation, or other rule evaluation method(s) for interpreting the network access request and comparing the interpretation to established rules for network access. Classifiers may be used, such as neural network classifiers or other classifiers that may be trained by machine learning.

The threat management facility 700 may include an asset classification facility 760. The asset classification facility will discover the assets present in the enterprise facility 702. A compute instance such as any of the compute instances 10-26 described herein may be characterized as a stack of assets. The one level asset is an item of physical hardware. The compute instance may be, or may be implemented on physical hardware, and may have or may not have a hypervisor, or may be an asset managed by a hypervisor. The compute instance may have an operating system (e.g., Windows, MacOS, Linux, Android, IOS). The compute instance may have one or more layers of containers. The compute instance may have one or more applications, which may be native applications, e.g., for a physical asset or virtual machine, or running in containers within a computing environment on a physical asset or virtual machine, and those applications may link libraries or other code or the like, e.g., for a user interface, cryptography, communications, device drivers, mathematical or analytical functions and so forth. The stack may also interact with data. The stack may also or instead interact with users, and so users may be considered assets.

The threat management facility may include entity models 762. The entity models may be used, for example, to determine the events that are generated by assets. For example, some operating systems may provide useful information for detecting or identifying events. For example, operating systems may provide process and usage information that is accessed through an API. As another example, it may be possible to instrument certain containers to monitor the activity of applications running on them. As another example, entity models for users may define roles, groups, permitted activities and other attributes.

The event collection facility 764 may be used to collect events from any of a wide variety of sensors that may provide relevant events from an asset, such as sensors on any of the compute instances 10-26, the application protection facility 750, a cloud computing instance 709 and so on. The events that may be collected may be determined by the entity models. There may be a variety of events collected. Events may include, for example, events generated by the enterprise facility 702 or the compute instances 10-26, such as by monitoring streaming data through a gateway such as firewall 10 and wireless access point 11, monitoring activity of compute instances, monitoring stored files/data on the compute instances 10-26 such as desktop computers, laptop computers, other mobile computing devices, and cloud computing instances 19, 709. Events may range in granularity. An exemplary event may be communication of a specific packet over the network. Another exemplary event may be the identification of an application that is communicating over a network.

The event logging facility 766 may be used to store events collected by the event collection facility 764. The event logging facility 766 may store collected events so that they can be accessed and analyzed by the analytics facility 768. Some events may be collected locally, and some events may be communicated to an event store in a central location or cloud facility. Events may be logged in any suitable format.

Events collected by the event logging facility 766 may be used by the analytics facility 768 to make inferences and observations about the events. These observations and inferences may be used as part of policies enforced by the security management facility. Observations or inferences about events may also be logged by the event logging facility 766.

When a threat or other policy violation is detected by the security management facility 722, the remedial action facility 728 may be used to remediate the threat. Remedial action may take a variety of forms, non-limiting examples including collecting additional data about the threat, terminating or modifying an ongoing process or interaction, sending a warning to a user or administrator, downloading a data file with commands, definitions, instructions, or the like to remediate the threat, requesting additional information from the requesting device, such as the application that initiated the activity of interest, executing a program or application to remediate against a threat or violation, increasing telemetry or recording interactions for subsequent evaluation, (continuing to) block requests to a particular network location or locations, scanning a requesting application or device, quarantine of a requesting application or the device, isolation of the requesting application or the device, deployment of a sandbox, blocking access to resources, e.g., a USB port, or other remedial actions. More generally, the remedial action facility 722 may take any steps or deploy any measures suitable for addressing a detection of a threat, potential threat, policy violation or other event, code or activity that might compromise security of a computing instance 10-26 or the enterprise facility 702.

While the above description of the threat management facility 700 describes various threats typically coming from a source outside the enterprise facility 702, it should be understood that the disclosed embodiments contemplate that threats may occur to the enterprise facility 702 by the direct actions, either intentional or unintentional, of a user or employee associated with the enterprise facility 702. Thus, reference to threats hereinabove may also refer to instances where a user or employee, either knowingly or unknowingly, performs data exfiltration from the enterprise facility 702 in a manner that the enterprise facility 702 wishes to prevent.

FIG. 14 is a diagram of an example computing device 800, according to an example embodiment. As shown, the computing device 800 includes one or more processors 802, non-transitory computer readable medium or memory 804, I/O interface devices 806 (e.g., wireless communications, etc.) and a network interface (not shown). The computer readable medium 804 may include an operating system 808, an application 810 for cold start user activity anomaly detection in a cloud computing environment and a database 812 in accordance with the systems and methods described herein.

In operation, the processor 802 may execute the application 810 stored in the computer readable medium 804. The application 810 may include software instructions that, when executed by the processor, cause the processor to perform operations for cold start user anomaly detection, as described and shown in FIGS. 1-6, with particular reference to the steps of the methodology shown in FIGS. 2 and 3. The database 812 is constructed and arranged to store one or more databases, for example, model data storage 111, activity log storage 113, and new user storage 118 described with reference to FIG. 1, and/or data for generating the anomaly detection operations described in FIGS. 5 and 6.

The application program 810 may operate in conjunction with the database 812 and the operating system 808. The device 800 may communicate with other devices (e.g., a wireless access point) via the I/O interface 806.

Although the foregoing figures illustrate various embodiments of the disclosed systems and methods, additional and/or alternative embodiments are contemplated as falling within the scope of this disclosure. For example, in one embodiment, this disclosure provides for a method for detecting cold start user activity anomalies in a cloud computing environment, comprising: receiving, by one or more processors of an anomaly detection system, historical activity data of users of a plurality of endpoint computers, the users arranged in an account; training, by the anomaly detection system, an average user baseline behavior model for the account from the historical activity data of the users arranged in the account; applying, by the anomaly detection system, the average user baseline behavior model to a cold start user activity; and detecting, by the anomaly detection system, an anomaly in response to a comparison between the cold start user activity and the average user baseline behavior model. The anomaly detection system displays an alert based on a determination from the comparison that at least one anomaly of the plurality of anomalies is detected by the cold start user activity deviating from the average user baseline behavior model by a predetermined threshold. The anomaly detection system displays an alert based on a determination from the comparison that at least one anomaly of the plurality of anomalies is detected by the cold start user activity deviating from the average user baseline behavior model by a predetermined threshold.

In another embodiment, the method further comprises providing at least one predefined rule regarding permissible computer activities of the users; combining, by the anomaly detection system, the average user baseline behavior model and the at least one predefined rule to the cold start user activity; and determining the anomaly when cold start user activity deviates from both the at least one predefined rule and the average user baseline behavior by a predetermined threshold.

In another embodiment, the method further comprises retraining, by the anomaly detection system, the average user baseline behavior model by adding user activity of the users in the account to the average user baseline behavior model.

In another embodiment, generating the average user baseline behavior model comprises: converting, by the anomaly detection system, the historical activity data of the users into a plurality of user sessions, each user session including user activity performed during a predetermined period of time; and training, by the anomaly detection system, the average user baseline behavior model with the user sessions.

In another embodiment, determining the plurality of anomaly detection model parameters comprises: generating, by the anomaly detection system, a plurality of features indicative of the historical activity patterns of the users of the account; calculating, by the anomaly detection system, an average feature value indicative of average user behavior in the account from the plurality of features; and determining, by the anomaly detection system, the anomaly detection model parameters from the average feature value.

In another example, in one embodiment, this disclosure provides for a method for detecting anomalies in a cloud computing environment, comprising: training, by the anomaly detection system, an account level user baseline behavior model for an account from activity patterns of a plurality of computer users of an account; generating, in response to training the average user baseline behavior model, an average user behavior model of the account; combining, by the anomaly detection system, the average user baseline behavior model and at least one predefined rule to an activity performed by a cold start user of the plurality of computer users; detecting, by the anomaly detection system, an anomaly in response to a comparison between the activity of the cold start user and the average user baseline behavior model; and displaying an alert based on a determination from the comparison that at least one anomaly of the plurality of anomalies is detected by the cold start user activity deviating from the average user baseline behavior model by a predetermined threshold.

In another embodiment, the method further comprises generating, by the anomaly detection system, a probability for the cold start user activity; comparing, by the anomaly detection system, the probability to a threshold defined by the anomaly detection model parameters; and detecting, by the anomaly detection system, the anomaly when the probability is less than the threshold.

In another embodiment, the method further comprises retraining, by the anomaly detection system, the average user baseline behavior model by adding user activity of the users in the account to the average user baseline behavior model.

In another embodiment, generating the average user baseline behavior model comprises: converting, by the anomaly detection system, the activity patterns of the computer users into a plurality of user sessions, each user session including user activity performed during a predetermined period of time; and training, by the anomaly detection system, the average user baseline behavior model with the user sessions.

In another embodiment, determining the plurality of anomaly detection model parameters comprises: generating, by the anomaly detection system, a plurality of features indicative of the activity patterns of the users of the account; calculating, by the anomaly detection system, an average feature value indicative of average user behavior in the account from the plurality of features; and determining, by the anomaly detection system, the anomaly detection model parameters from the average feature value.

In another embodiment, the method further comprises transitioning from a cold start model of the cold start user to a custom anomaly detection model in response to a receipt by the anomaly detection model of additional cold start user data; and training the custom anomaly detection model using activity data of the cold start user instead of the activity patterns of the plurality of the computer users.

In another embodiment, the method further comprises benchmarking activity data of the cold start user against an average user in a same or similar environment as the cold start user; determining an anomaly if the activity data deviates from that of the average user by a predetermined threshold.

In another embodiment, the method further comprises the anomaly that is detected includes a computer configuration error of the cold start user.

In another example, in one embodiment, this disclosure provides for a computer program product for prioritizing security events, the computer program product comprising computer-readable program code executable by one or more processors of a computer system to cause the computer system to detect anomalies in a cloud computing environment comprising: training an account level user baseline behavior model for from activity patterns of a plurality of computer users of an account; creating, in response to training the average user baseline behavior model, an average user behavior model of the account; combining the average user baseline behavior model and at least one predefined rule to an activity performed by a cold start user of the plurality of computer users; detecting, by the anomaly detection system, an anomaly in response to a comparison between the activity of the cold start user and the average user baseline behavior model; and displaying an alert based on a determination from the comparison that at least one anomaly of the plurality of anomalies is detected by the cold start user activity deviating from the average user baseline behavior model by a predetermined threshold.

In another embodiment, the computer system detects the anomalies in a cloud computing environment further comprising: generating, by the anomaly detection system, a probability for the cold start user activity; comparing, by the anomaly detection system, the probability to a threshold defined by the anomaly detection model parameters; and detecting, by the anomaly detection system, the anomaly when the probability is less than the threshold.

In another embodiment, the computer system detects the anomalies in a cloud computing environment further comprising: retraining, by the anomaly detection system, the average user baseline behavior model by adding user activity of the users in the account to the average user baseline behavior model.

In another embodiment, generating the average user baseline behavior model comprises: converting, by the anomaly detection system, the activity patterns of the computer users into a plurality of user sessions, each user session including user activity performed during a predetermined period of time; and training, by the anomaly detection system, the average user baseline behavior model with the user sessions.

In another embodiment, determining the plurality of anomaly detection model parameters comprises: generating, by the anomaly detection system, a plurality of features indicative of the activity patterns of the users of the account; calculating, by the anomaly detection system, an average feature value indicative of average user behavior in the account from the plurality of features; and determining, by the anomaly detection system, the anomaly detection model parameters from the average feature value.

In another embodiment, the computer system detects the anomalies in a cloud computing environment further comprising: transitioning from a cold start model of the cold start user to a custom anomaly detection model in response to a receipt by the anomaly detection model of additional cold start user data; and training the custom anomaly detection model using activity data of the cold start user instead of the activity patterns of the plurality of the computer users.

In another embodiment, the computer system detects the anomalies in a cloud computing environment further comprising: benchmarking activity data of the cold start user against an average user in a same or similar environment as the cold start user; and determining an anomaly if the activity data deviates from that of the average user by a predetermined threshold.

It will be appreciated that the modules, processes, systems, and sections described above may be implemented in hardware, hardware programmed by software, software instructions stored on a non-transitory computer readable medium or a combination of the above. A system as described above, for example, may include a processor configured to execute a sequence of programmed instructions stored on a non-transitory computer readable medium. For example, the processor may include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions may be compiled from source code instructions provided in accordance with a programming language such as Java, C, C++, C#.net, assembly or the like. The instructions may also comprise code and data objects provided in accordance with, for example, the Visual Basic™ language, or another structured or object-oriented programming language. The sequence of programmed instructions, or programmable logic device configuration software, and data associated therewith may be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes, systems, and sections may be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above may be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules) may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein may be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that may be used on a variety of computer platforms. Alternatively, embodiments of the disclosed method, system, and computer program product may be implemented partially or fully in hardware using, for example, standard logic circuits or a VLSI design. Other hardware or software may be used to implement embodiments depending on the speed and/or efficiency requirements of the systems, the particular function, and/or particular software or hardware system, microprocessor, or microcomputer being utilized. Embodiments of the method, system, and computer program product may be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) may be implemented in software executed on a programmed general-purpose computer, a special purpose computer, a microprocessor, a network server or switch, or the like.

It is, therefore, apparent that there is provided, in accordance with the various embodiments disclosed herein, methods, systems and computer readable media for applying an appropriate security policy to network traffic to prevent intrusion attempts to the containerized computing environment.

While the disclosed subject matter has been described in conjunction with a number of embodiments, it is evident that many alternatives, modifications and variations would be, or are, apparent to those of ordinary skill in the applicable arts. Accordingly, Applicants intend to embrace all such alternatives, modifications, equivalents and variations that are within the spirit and scope of the disclosed subject matter. It should also be understood that references to items in the singular should be understood to include items in the plural, and vice versa, unless explicitly stated otherwise or clear from the context. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

1. A method for detecting cold start user activity anomalies in a cloud computing environment, comprising:
receiving, by one or more processors of an anomaly detection system, historical activity data of users of a plurality of endpoint computers, the users arranged in an account;
training, by the anomaly detection system, an average user baseline behavior model for the account from the historical activity data of the users arranged in the account;
applying, by the anomaly detection system, the average user baseline behavior model to a cold start user activity;
detecting, by the anomaly detection system, a plurality of anomalies in response to a comparison between the cold start user activity and the average user baseline behavior model; and
displaying, by the anomaly detection system, an alert based on a determination from the comparison that at least one anomaly of the plurality of anomalies is detected by the cold start user activity deviating from the average user baseline behavior model by a predetermined threshold.

2. The method of claim 1, further comprising:
providing the at least one predefined rule regarding permissible computer activities of the users;
combining, by the anomaly detection system, the average user baseline behavior model and the at least one predefined rule to the cold start user activity; and
determining the anomaly when cold start user activity deviates from both the at least one predefined rule and the average user baseline behavior by the predetermined threshold.

3. The method of claim 1, further comprising:
retraining, by the anomaly detection system, the average user baseline behavior model by adding user activity of the users in the account to the average user baseline behavior model.

4. The method of claim 1, wherein generating the average user baseline behavior model comprises:
converting, by the anomaly detection system, the historical activity data of the users into a plurality of user sessions, each user session including user activity performed during a predetermined period of time; and
training, by the anomaly detection system, the average user baseline behavior model with the user sessions.

5. The method of claim 1, wherein determining the plurality of anomaly detection model parameters comprises:
generating, by the anomaly detection system, a plurality of features indicative of the historical activity patterns of the users of the account;
calculating, by the anomaly detection system, an average feature value indicative of average user behavior in the account from the plurality of features; and
determining, by the anomaly detection system, the anomaly detection model parameters from the average feature value.

6. A method for detecting anomalies in a cloud computing environment, comprising:
training, by an anomaly detection system, an account level user baseline behavior model for an account from activity patterns of a plurality of computer users of an account;
generating, in response to training the average user baseline behavior model, an average user behavior model of the account;
combining, by the anomaly detection system, the average user baseline behavior model and at least one predefined rule to an activity performed by a cold start user of the plurality of computer users;
detecting, by the anomaly detection system, an anomaly in response to a comparison between the activity of the cold start user and the average user baseline behavior model; and
displaying, by the anomaly detection system, an alert based on a determination from the comparison that the anomaly is detected by the cold start user activity deviating from the average user baseline behavior model by a predetermined threshold.

7. The method of claim 6, further comprising:
generating, by the anomaly detection system, a probability for the cold start user activity;
comparing, by the anomaly detection system, the probability to a threshold defined by the anomaly detection model parameters; and
detecting, by the anomaly detection system, the anomaly when the probability is less than the threshold.

8. The method of claim 6, further comprising:
retraining, by the anomaly detection system, the average user baseline behavior model by adding user activity of the users in the account to the average user baseline behavior model.

9. The method of claim 6, wherein generating the average user baseline behavior model comprises:
converting, by the anomaly detection system, the activity patterns of the computer users into a plurality of user sessions, each user session including user activity performed during a predetermined period of time; and
training, by the anomaly detection system, the average user baseline behavior model with the user sessions.

10. The method of claim 6, wherein determining the plurality of anomaly detection model parameters comprises:
generating, by the anomaly detection system, a plurality of features indicative of the activity patterns of the users of the account;
calculating, by the anomaly detection system, an average feature value indicative of average user behavior in the account from the plurality of features; and
determining, by the anomaly detection system, the anomaly detection model parameters from the average feature value.

11. The method of claim 6, further comprising:
transitioning from a cold start model of the cold start user to a custom anomaly detection model in response to a receipt by the anomaly detection model of additional cold start user data; and
training the custom anomaly detection model using activity data of the cold start user instead of the activity patterns of the plurality of the computer users.

12. The method of claim 6, further comprising:
benchmarking activity data of the cold start user against an average user in a same or similar environment as the cold start user;
determining an anomaly if the activity data deviates from that of the average user by a predetermined threshold.

13. The method of claim 6, wherein the anomaly that is detected includes a computer configuration error of the cold start user.

14. A computer program product for prioritizing security events, the computer program product comprising computer-readable program code executable by one or more processors of a computer system to cause the computer system to detect anomalies in a cloud computing environment comprising:
training an account level user baseline behavior model for from activity patterns of a plurality of computer users of an account;
creating, in response to training the average user baseline behavior model, an average user behavior model of the account;
combining the average user baseline behavior model and at least one predefined rule to an activity performed by a cold start user of the plurality of computer users;
detecting, by the anomaly detection system, an anomaly in response to a comparison between the activity of the cold start user and the average user baseline behavior model; and
displaying an alert based on a determination from the comparison that the anomaly is detected by the cold start user activity deviating from the average user baseline behavior model by a predetermined threshold.

15. The computer program product of claim 14, wherein the computer system detects the anomalies in a cloud computing environment further comprising:
generating, by the anomaly detection system, a probability for the cold start user activity;
comparing, by the anomaly detection system, the probability to a threshold defined by the anomaly detection model parameters; and
detecting, by the anomaly detection system, the anomaly when the probability is less than the threshold.

16. The computer program product of claim 14, wherein the computer system detects the anomalies in a cloud computing environment further comprising:
retraining, by the anomaly detection system, the average user baseline behavior model by adding user activity of the users in the account to the average user baseline behavior model.

17. The computer program product of claim 14, wherein generating the average user baseline behavior model comprises:
converting, by the anomaly detection system, the activity patterns of the computer users into a plurality of user sessions, each user session including user activity performed during a predetermined period of time; and
training, by the anomaly detection system, the average user baseline behavior model with the user sessions.

18. The computer program product of claim 14, wherein determining the plurality of anomaly detection model parameters comprises:
generating, by the anomaly detection system, a plurality of features indicative of the activity patterns of the users of the account;
calculating, by the anomaly detection system, an average feature value indicative of average user behavior in the account from the plurality of features; and
determining, by the anomaly detection system, the anomaly detection model parameters from the average feature value.

19. The computer program product of claim 14, wherein the computer system detects the anomalies in a cloud computing environment further comprising:
transitioning from a cold start model of the cold start user to a custom anomaly detection model in response to a receipt by the anomaly detection model of additional cold start user data; and
training the custom anomaly detection model using activity data of the cold start user instead of the activity patterns of the plurality of the computer users.

20. The computer program product of claim 14, further comprising:
benchmarking activity data of the cold start user against an average user in a same or similar environment as the cold start user;
determining an anomaly if the activity data deviates from that of the average user by a predetermined threshold.
